(19) United States
(12) Patent Application Publication
(10) Pub. No.: US 2004/0126231 A1
(43) Pub. Date: Jul. 1, 2004

(54) Compressor wheel assembly

(76) Inventor: Anthony Billington, Huddersfield (GB)

Correspondence Address: Woodard, Emhardt, Moriarty, McNett & Henry LLP, Bank One Center/Tower, Suite 3700, 111 Monument Circle, Indianapolis, IN, 46204-5137, US

(21) Appl. No.: 10/691,077

(22) Filed: Oct. 22, 2003

(30) Foreign Application Priority Data
Oct. 24, 2002 (GB) 0224723.7

(51) Int. Cl. F03B 11/00

(52) U.S. Cl. 415/216.1; 416/244 A

(57) ABSTRACT

A compressor wheel assembly comprises a compressor wheel (7) mounted to a rotating shaft (8), extending through a bore (21) provided along the rotational axis of wheel (7). The bore (21) has an inner diameter greater than the outer diameter of the shaft (8) and a cylindrical sleeve (122) is located concentrically around the shaft (8) to thereby support the shaft (8) co-axially within the bore (21).

This invention relates to the assembly of a compressor wheel to a rotating shaft. In particular, the invention relates to the compressor wheel assembly of a turbocharger.

Turbochargers are well known devices for supplying air to the intake of an internal combustion engine at pressures above atmospheric (boost pressures). A conventional turbocharger essentially comprises an exhaust gas driven turbine wheel mounted on a rotatable shaft within a turbine housing. Rotation of the turbine wheel rotates a compressor wheel mounted on the other end of the shaft within a compressor housing. The compressor wheel delivers compressed air to the intake manifold of the engine, thereby increasing engine power. The shaft is supported on journal and trust bearings located within a central bearing housing connected between the turbine and compressor wheel housings.

A conventional compressor wheel comprises an array of blades extending from a central hub provided with a bore for receiving one end of the turbocharger shaft. The compressor wheel is secured to the shaft by a nut which threads onto the end of the shaft where it extends through the wheel bore, and bears against the nose end of the wheel to clamp the wheel against a shaft shoulder (or other radially extending abutment that rotates with the shaft).

Modern demands on turbocharger performance require increased airflow from a turbocharger of a given size, leading to increased rotational speeds, for instance in excess of 100,000 rpm. To accommodate such high rotational speeds the turbocharger bearings, and thus the turbocharger shaft diameter, must be minimized. However, the use of a relatively small diameter shaft is problematical with the conventional compressor wheel mounting assembly. That is, it can be difficult to machine a sufficiently narrow bore through the compressor wheel to the required degree of accuracy (the bore must be concentric about the axis of rotation of the wheel if the wheel is to be rotationally balanced). As the diameter of the bore reduces there is a corresponding reduction in the size, and therefore strength, of the tool required to machine the bore. Even where the required accuracy is achievable, increased machining time and tool wear issues may prevent the process from being economically viable.

The above problem is exacerbated as continued turbocharger development requires the use of higher performance materials, such as titanium, which are even harder to machine than the aluminium alloys conventionally used.

One possible way of avoiding the above problem is to use a so-called ‘bore-less’ compressor wheel such as disclosed in U.S. Pat. No. 4,705,463. With this compressor wheel assembly only a relatively short threaded bore is provided in the compressor wheel to receive the threaded end of a shortened turbocharger shaft However, such assemblies can also experience balancing problems as the threaded connection between the compressor wheel and the shaft, and the clearance inherent in such a connection, may make it difficult to maintain the required degree of concentricity.

It is an object of the present invention to obviate or mitigate the above problems.

According to the present invention there is provided a compressor wheel assembly comprising a compressor wheel mounted to a rotating shaft, the shaft extending through a bore provided along the rotational axis of the wheel, wherein the bore has an inner diameter greater than the outer diameter of the portion of the shaft which passes through the compressor wheel, and a cylindrical sleeve is located concentrically around the shaft between the inner surface of the bore and the outer surface of the shaft to thereby support the shaft co-axially within the bore.

The present invention enables the shaft bore to be machined with a diameter suitable for accurate mass productions the bore diameter then effectively being reduced to suite the shaft diameter by provision of said sleeve. The manufacturing difficulties of the prior art are therefore avoided.

The sleeve may be pre-fitted to the compressor wheel. Accordingly, the present invention also provides a compressor wheel for a turbocharger, which in use is mounted to one end of a turbocharger shaft, wherein the compressor wheel defines an internal axial through bore of a relatively large diameter, and is provided with a cylindrical sleeve of a relatively small inner diameter, selected to correspond to the diameter of the shaft, located co-axially within said bore.

Other preferred features of the invention will become apparent from the description below.

Specific embodiments of the present invention will now be described, by way of example only, with reference to the accompanying drawings, in which:

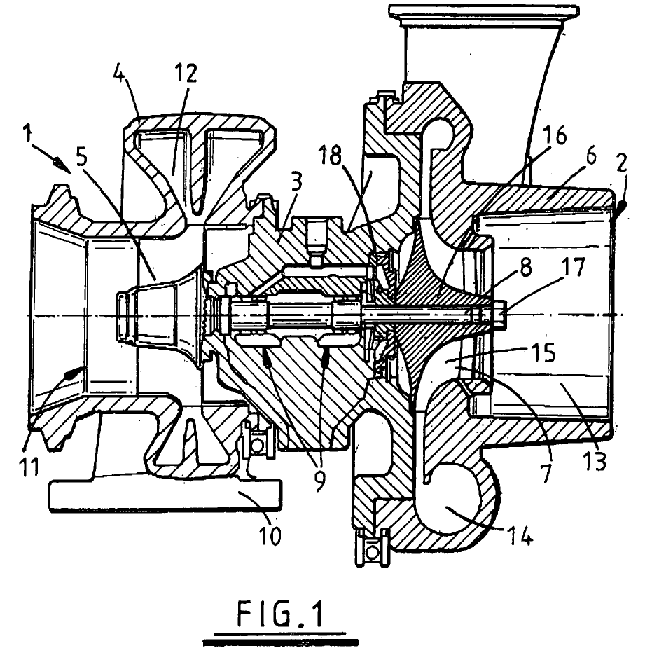

FIG. 1 is an axial cross-section through a conventional turbocharger illustrating the major components of a turbocharger and a conventional compressor wheel assembly; and

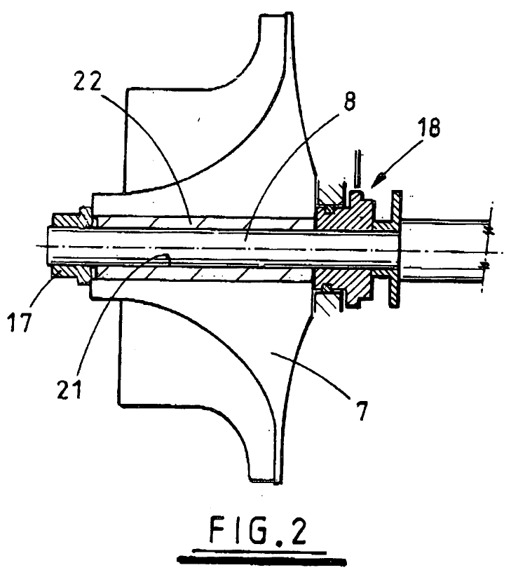

FIG. 2 is a cross-section through a compressor wheel assembly in accordance with the present invention.

Referring first to FIG. 1, this illustrates the basic components of a conventional centripetal type turbocharger. The turbocharger comprises a turbine 1 joined to a compressor 2 via a central bearing housing 3. The turbine 1 comprises a turbine housing 4 which houses a turbine wheel 5. Similarly, the compressor 2 comprises a compressor housing 6 which houses a compressor wheel 7. The turbine wheel 5 and compressor wheel 7 are mounted on opposite ends of a common shaft 8 which is supported on bearing assemblies 9 within the bearing housing 3.

The turbine housing 4 is provided with an exhaust gas inlet 10 and an exhaust gas outlet 11. The inlet 10 directs incoming exhaust gas to an annular inlet chamber 12 surrounding the turbine wheel 5. The exhaust gas flows through the turbine and into the outlet 11 via a circular outlet opening which is co-axial with the turbine wheel 5. Rotation of the turbine wheel 5 rotates the compressor wheel 7 which draws in air through axial inlet 13 and delivers compressed air to the engine intake via an annular outlet volute 14.

Referring in more detail to the compressor wheel assembly, the compressor wheel comprises a plurality of blades 15 extending from a central hub 16 which is provided with a through bore to receive one end of the shaft 8. The shaft 8 extends slightly from the nose of the compressor wheel 7 and is threaded to receive a nut 17 which bears against the compressor wheel nose to clamp the compressor wheel 7 against a thrust bearing and oil seal assembly 18. Details of the thrust bearing/oil seal assembly may vary and are not important to undemanding of the compressor wheel mounting arrangement. Essentially, the compressor wheel 7 is prevented from slipping on the shaft 8 by the clamping force applied by the nut 17.

Problems associated with the conventional compressor wheel assembly described above are discussed in the introduction to this specification.

FIG. 2 illustrates a compressor wheel assembly in accordance with the preset invention. Details of the shaft 8, thrust bearing and seal assembly 18, and clamp nut 17 may be entirely conventional, as for instance illustrated in FIG. 1.

Where the assembly of FIG. 2 differs significantly from the assembly of FIG. 1 is that in accordance with the present invention the compressor wheel bore 21 has a relatively large diameter (i.e. larger than the diameter of the shaft 8) and in particular is of a size that can be easily machined and mass produced to the required accuracy. The diameter of the bore 21 is then effectively reduced to the diameter of the shaft 8 by introduction of a cylindrical sleeve 22 in to the bore 21. The sleeve 22 has an outer diameter corresponding to the inner diameter of the bore 21, and an inner diameter corresponding to the outer diameter of the shaft 8. The shaft 8 is therefore accurately located and maintained along the axis of the bore 21.

With the clamping nut arrangement of FIG. 2, the sleeve 21 is provided slightly shorter than the length of the bore 20 to ensure that the clamping force is transferred through the compressor wheel and not through the sleeve.

Since the sleeve 21 is not subjected to the same stresses as the compressor wheel, it may be manufactured from a material which is much easier to work than the material of the compressor wheel.

Accordingly, with the present invention the relatively small diameter bore required to mount a compressor wheel on to a small diameter shaft can be provided with a high degree of accuracy and manufacturing ease. Since the sleeve 21 fits within the bore 20 in the same manner as would a larger diameter shaft, wheel balancing issues are essentially unchanged. In addition, with the present invention it is not necessary to modify other components of the compressor wheel assembly, such as the wheel clamping arrangement.

1. A compressor wheel assembly comprising a compressor wheel mounted to a rotating shaft, the shaft extending through a bore provided along the rotational axis of the wheel wherein the bore has an inner diameter greater than the outer diameter of the portion of the shaft which passes through the compressor wheel, and a cylindrical sleeve is located concentrically around the shaft between the inner surface of the bore and the outer surface of the shaft to thereby support the shaft co-axially within the bore.

2. A compressor wheel assembly according to claim 1, wherein the axial length of the sleeve is less than the axial length of the bore through the compressor wheel.

3. A compressor wheel assembly according to claim 1, wherein the wheel is retained on the shaft by a nut which threads to one end of the shaft to apply an axial clamping force to the wheel.

4. A compressor wheel assembly according to claim 3, wherein the nut bears directly or indirectly against a nose portion of the wheel to clamp the wheel against an abutment and therefore prevent axial movement of the wheel along the shaft.

5. A compressor wheel assembly according to claim 1, wherein said sleeve is press fitted within the bore of the compressor wheel prior to assembly of the compressor wheel on the shaft.

6. A compressor wheel for a turbocharger, which in use is mounted to one end of a turbocharger shaft, wherein the compressor wheel defines an internal axial through bore of a relatively large diameter, and is provided with a cylindrical sleeve of a relatively small inner diameter, selected to correspond to the diameter of the shaft, located co-axially within said bore.

7. A compressor wheel according to claim 6, wherein the axial length of the sleeve is shorter than the axial length of the through bore.

8. A turbocharger including a compressor wheel assembly comprising a compressor wheel mounted to a rotating shaft, the shaft extending through a bore provided along the rotational axis of the wheel, wherein the bore has an inner diameter greater than the outer diameter of the portion of the shaft which passes through the compressor wheel, and a cylindrical sleeve is located concentrically around the shaft between the inner surface of the bore and the outer surface of the shaft to thereby support the shaft co-axially within the bore.

9. A turbocharger including a compressor wheel for a turbocharger, which in use is mounted to one end of a turbocharger shaft, wherein the compressor wheel defines an internal axial through bore of a relatively large diameter, and is provided with a cylindrical sleeve of a relatively small inner diameter, selected to correspond to the diameter of the shaft, located co-axially within said bore.
